(19) United States
(12) Patent Application Publication
(10) Pub. No.: US 2023/0258289 A1
(43) Pub. Date: Aug. 17, 2023

(54) Pipe Coupling Assembly

(71) Applicants: Steve Douthitt, Rancho Cordova, CA (US); Michele Douthitt, Rancho Cordova, CA (US)

(72) Inventors: Steve Douthitt, Rancho Cordova, CA (US); Michele Douthitt, Rancho Cordova, CA (US)

(21) Appl. No.: 17/671,802

(22) Filed: Feb. 15, 2022

(51) Int. Cl. F16L 37/08; F16L 21/00

(52) U.S. Cl. CPC F16L 37/08; F16L 21/00

(57) ABSTRACT

A pipe coupling assembly for roughing-in an electrical conduit in a construction project includes a pipe that has an inside diameter of 1.05 inches thereby facilitating the pipe to insertably receive a conduit which has an outside diameter of less than 1.05 inches. In this way the pipe facilitates an electrician to accomplish a rough-in electrical conduit in a construction project. The pipe has a length of less than 36.0 inches such that the pipe can be easily carried and installed by a construction worker.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to coupling devices and more particularly pertains to a new coupling device for roughing in an electrical conduit in a construction project. The device includes a pipe which has an inside diameter of 1.05 inches thereby facilitating the pipe to accommodate a 0.75 inch trade size polyvinylchloride conduit. Additionally, the pipe has a length of approximately 24.0 inches thereby facilitating the pipe to be extended upwardly through a concrete floor slab.

### Description of Related Art Including Information Disclosed Under 37 CFR 1.97 and 1.98

The prior art relates to coupling devices including a variety of pipe coupling devices that each includes a pair of threaded sections for threadably attaching pipes together. The prior art discloses a first pipe with an annular recess for joining to an annular gasket on a second pipe. The prior art discloses a pipe coupler that includes a sleeve with a ridge centrally positioned in the sleeve. The prior art discloses a variety of pipe couplers which each includes structural elements specifically designed to engage a pipe for attaching the pipe coupler to the pipe.

### BRIEF SUMMARY OF THE INVENTION

An embodiment of the disclosure meets the needs presented above by generally comprising a pipe that has an inside diameter of 1.05 inches thereby facilitating the pipe to insertably receive a conduit which has an outside diameter of less than 1.05 inches. In this way the pipe facilitates an electrician to accomplish a rough-in electrical conduit in a construction project. The pipe has a length of less than 36.0 inches such that the pipe can be easily carried and installed by a construction worker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pipe coupling assembly according to an embodiment of the disclosure.

FIG. 2 is a front view of an embodiment of the disclosure.

FIG. 3 is a perspective view of an embodiment of the disclosure showing a pipe engaging a 90.0 degree elbow in a concrete slab.

FIG. 4 is a perspective in-use view of an embodiment of the disclosure showing a pipe being removed from a concrete slab.

### DETAILED DESCRIPTION OF THE INVENTION

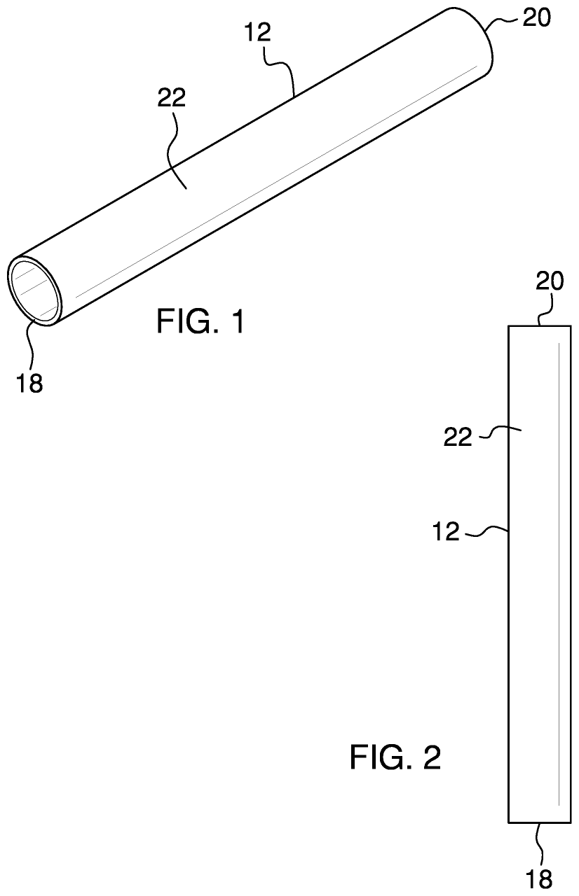

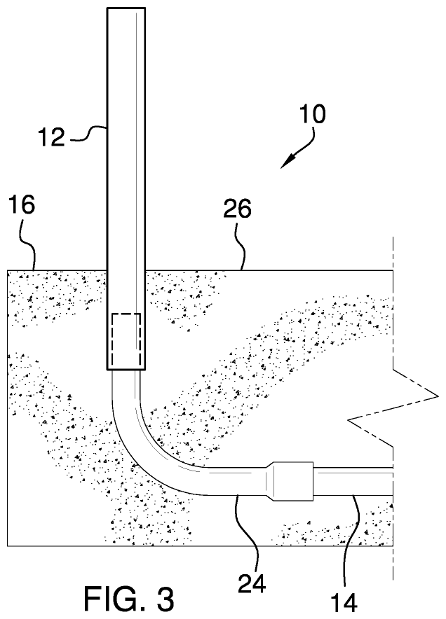

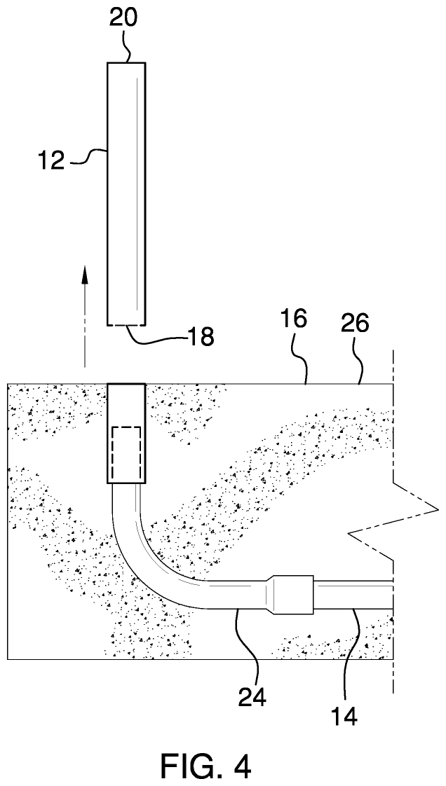

With reference now to the drawings, and in particular to FIGS. 1 through 4 thereof, a new coupling device embodying the principles and concepts of an embodiment of the disclosure and generally designated by the reference numeral 10 will be described.

As best illustrated in FIGS. 1 through 4, the pipe coupling assembly 10 generally comprises a pipe 12 that has an inside diameter of 1.05 inches thereby facilitating the pipe 12 to insertably receive a conduit 14 which has an outside diameter of less than 1.05 inches. In this way the pipe 12 facilitates an electrician to accomplish a rough-in electrical conduit in a construction project. The construction project may be a commercial building or other similar type of construction project that involves running electrical wiring upwardly through a concrete floor slab 16. The pipe 12 has a length of less than 36.0 inches thereby facilitating the pipe 12 to be easily carried and installed by a construction worker.

The pipe 12 has a first end 18, a second end 20 and an outer wall 22 extending between the first end 18 and the second end 20. The outer wall 22 has an outside diameter of 1.3 inches such that the pipe 12 conforms to dimensions of a 0.75 inch trade size conduit 14. Additionally, the pipe 12 is elongated between the first end 18 and the second end 20 to a distance of at least 24.0 inches. In this way the pipe 12 can extend fully through a concrete floor slab 16 of the construction project. The pipe 12 may be comprised of polyvinylchloride or other similar material that is commonly employed in commercial construction projects.

In use, the electrical conduit 14 is trimmed to a pre-determined length according to construction plans for the construction project. A 90.0 degree elbow 24 is installed on the electrical conduit 14 if electrical wiring that will be subsequently routed through the electrical conduit 14 is to be extended upwardly through a concrete floor slab 16. The first end 18 of the pipe 12 is installed on the 90.0 elbow such that the pipe 12 is vertically oriented. A concrete floor slab 16 is poured over the electrical conduit 14 and around the pipe 12. Furthermore, the pipe 12 may be cut flush with a top surface 26 of the concrete floor slab 16 when the concrete floor slab 16 is cured. In this way the pipe 12 does not pose an obstacle for construction traffic on the concrete floor slab 16 thereby inhibiting the pipe 12 from being damaged during construction activities. The pipe 12 may be coupled to the electrical conduit 14 if electrical wiring that will be subsequently routed through the electrical conduit 14 is to be extended through a wall, for example.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe coupling assembly for construction rough-in applications, said assembly comprising:
a pipe having an inside diameter of 1.05 inches thereby facilitating said pipe to insertably receive a conduit having an outside diameter of less than 1.05 inches wherein said pipe is configured to facilitate an electrician to accomplish a rough-in electrical conduit in a construction project, said pipe having a length of less than 36.0 inches wherein said pipe is configured to be easily carried and installed by a construction worker.

2. The assembly according to claim 1, wherein said pipe an outer wall, said outer wall having an outside diameter of 1.3 inches wherein said pipe is configured to conform to dimensions of a 0.75 inch trade size conduit.

3. The assembly according to claim 1, wherein said pipe has a first end and a second end, said pipe being elongated between said first end and said second end to a distance of at least 24.0 inches wherein said pipe is configured to extend fully through a concrete floor slab of the construction project.

4. The assembly according to claim 1, wherein said pipe has a first end, a second end and an outer wall extending between said first end and said second end, said outer wall having an outside diameter of 1.3 inches wherein said pipe is configured to conform to dimensions of a 0.75 inch trade size conduit, said pipe being elongated between said first end and said second end to a distance of at least 24.0 inches wherein said pipe is configured to extend fully through a concrete floor slab of the construction project.

5. A pipe coupling system for construction rough-in applications, said system comprising:
an electrical coupling having dimensions conforming to 0.75 inch trade size conduit;
a pipe having an inside diameter of 1.05 inches thereby facilitating said pipe to insertably receive said electrical conduit wherein said pipe is configured to facilitate an electrician to accomplish a rough-in of the electrical conduit in a construction project, said pipe having a first end, a second end and an outer wall extending between said first end and said second end, said outer wall having an outside diameter of 1.3 inches wherein said pipe is configured to conform to dimensions of a 0.75 inch trade size conduit, said pipe being elongated between said first end and said second end to a distance of at least 24.0 inches wherein said pipe is configured to extend fully through a concrete floor slab of the construction project; and
a concrete floor slab being poured over said electrical conduit such that said pipe extends through said concrete floor slab wherein said pipe is configured to facilitate electrical wiring to be wired through said electrical conduit and outwardly through said concrete floor slab, said concrete floor slab being poured to a thickness being less than 24.0 inches thereby facilitating said pipe to extend fully through said concrete floor slab.

6. A method of roughing-in electrical conduit in a construction project, the steps of the method comprising:
providing a pipe having an inside diameter of 1.05 inches and a length of at least 24.0 inches;
providing an electrical coupling conforming to 0.75 inch trade size;
providing a 90.0 degree elbow fitting conforming to 0.75 inch trade size;
cutting said electrical conduit to a pre-determined length according to construction blueprints;
installing said 90.0 elbow on said electrical conduit;
installing said pipe into said 90.0 elbow such that said pipe is vertically oriented;
pouring a concrete slab over said electrical conduit and around said pipe;
cutting said pipe flush with a top surface of said concrete slab when said concrete slab is cured;
filling said pipe with a packing wherein said packing is configured to inhibit debris from falling into said pipe; and
painting a marking on said top surface of said concrete slab when said pipe is cut flush with said top surface of said concrete slab wherein said marking is configured to facilitate said pipe to be visually located during subsequent construction applications.
